(19) United States
(12) Patent Application Publication
(10) Pub. No.: US 2009/0132557 A1
(43) Pub. Date: May 21, 2009

(54) USING HIERARCHICAL GROUPINGS TO ORGANIZE GRC GUIDELINES, POLICIES, CATEGORIES, AND RULES

(76) Inventors: Richard J. Cohen, Austin, TX (US); Randolph M. Forlenza, Austin, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(21) Appl. No.: 11/942,188

(22) Filed: Nov. 19, 2007

(51) Int. Cl. G06F 7/00

(52) U.S. Cl. 707/100

(57) ABSTRACT

A system and methodology are provided for using hierarchical groupings to organize governance, risk, and compliance (GRC) policies and rules. The groupings are based on categorizations that can be arbitrarily represented by both predetermined and user-defined hierarchical policy naming schemes. Once GRC regulatory and compliance policies and rules are grouped to accommodate company policies, testing can be designed around groups of policies and/or rules and scheduled to align with schedule and timing requirements. By allowing a policy or rule to be associated with multiple hierarchies, a single execution of a policy or rule can be associated with, managed from, and satisfy multiple regulatory and compliance needs with one effort.

### BACKGROUND

1. Technical Field

The present application relates generally to an improved data processing system and method. More specifically, the present application is directed to using hierarchical groupings to organize governance, risk, and compliance guidelines, policies, categories, and rules.

2. Description of Related Art

Customers are under increasing pressure to adhere to regulatory guidelines and governance, risk, and compliance (GRC) policies. These guidelines and policies are driven by legal, business, and internal requirements. To determine if their CRC objectives are achieved, organizations require GRC adherence across the business.

The goals of the GRC process are determined by a set of GRC objectives to be measured. One set of compliance rules and policies may be tested for one regulation, such as Sarbanes-Oxley, for example, while another set of rules and policies may be tested for industry-specific regulation, such as Basel II. A third set may support internal corporate audit security requirements. The Sarbanes-Oxley Act of 2002 (Pub. L. No. 107-204, 116 Stat. 745), also known as the Public Company Accounting Reform and Investor Protection Act of 2002 and commonly called SOX or Sarbox, is a United States federal law signed on Jul. 30, 2002, in response to a number of major corporate and accounting scandals. Basel II is the second of the Basel Accords, which are recommendations on banking laws and regulations issued by the Basel Committee on Banking Supervision. The purpose of Basel II is to create an international standard that banking regulators can use when creating regulations concerning the capital banks need to put aside to guard against the various types of financial and operational risks banks face.

Many rules and policies associated with many of the guidelines overlap and often are managed and subsequently tested in the same or different contexts during various compliance cycles. Customers do not have a good mechanism to organize the rules associated with these guidelines, policies, and rules that is flexible enough for their efficient management. The efficient management of guidelines, policies and rules are essential in order to perform tests, eliminate duplication, and understand which rules and policies belong to which initiative(s).

Many products claim to support regulatory and compliance guidelines and to cover multiple domains. The methods used are to designate specific reports or policies to support a given regulation. There is no indication that any compliance rule can support multiple regulations. Compliance managers must look at each set of rules as if they were unique to a particular guideline, which aggravates the problem of managing the rules and policies due to duplication and redundancy and the resultant loss of efficiency. Users can be burdened with the need to maintain multiple instantiations of a rule, even if the rule has equal applicability across multiple regulations or domains.

### SUMMARY

The illustrative embodiments recognize the disadvantages of the prior art and provide a system and methodology for using hierarchical groupings to organize governance, risk, and compliance (GRC) policies and rules. The groupings are based on categorizations that can be arbitrarily represented by both predetermined and user-defined hierarchical policy naming schemes. Once GRC regulatory and compliance policies and rules are grouped to accommodate company policies, testing can be designed around groups of policies and/or rules and scheduled to align with schedule and timing requirements. By allowing a policy or rule to be associated with multiple hierarchies, a single execution of a policy or rule can be associated with, managed from, and satisfy multiple regulatory and compliance needs with one effort.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an exemplary representation of an exemplary distributed data processing system in which aspects of the illustrative embodiments may be implemented;

FIG. 2 is a block diagram of an exemplary data processing system in which aspects of the illustrative embodiments may be implemented;

FIG. 3 is a diagram illustrating an example hierarchy of guidelines, categories, policies, and rules in accordance with an illustrative embodiment;

FIG. 4 is a block diagram of a system for managing groups of GRC regulatory and compliance policies and rules in accordance with an illustrative embodiment; and

FIGS. 5A and 5B is a flowchart illustrating operation of a system for managing groups of GRC regulatory and compliance policies and rules in accordance with an illustrative embodiment.

### DETAILED DESCRIPTION OF THE ILLUSTRATIVE EMBODIMENTS

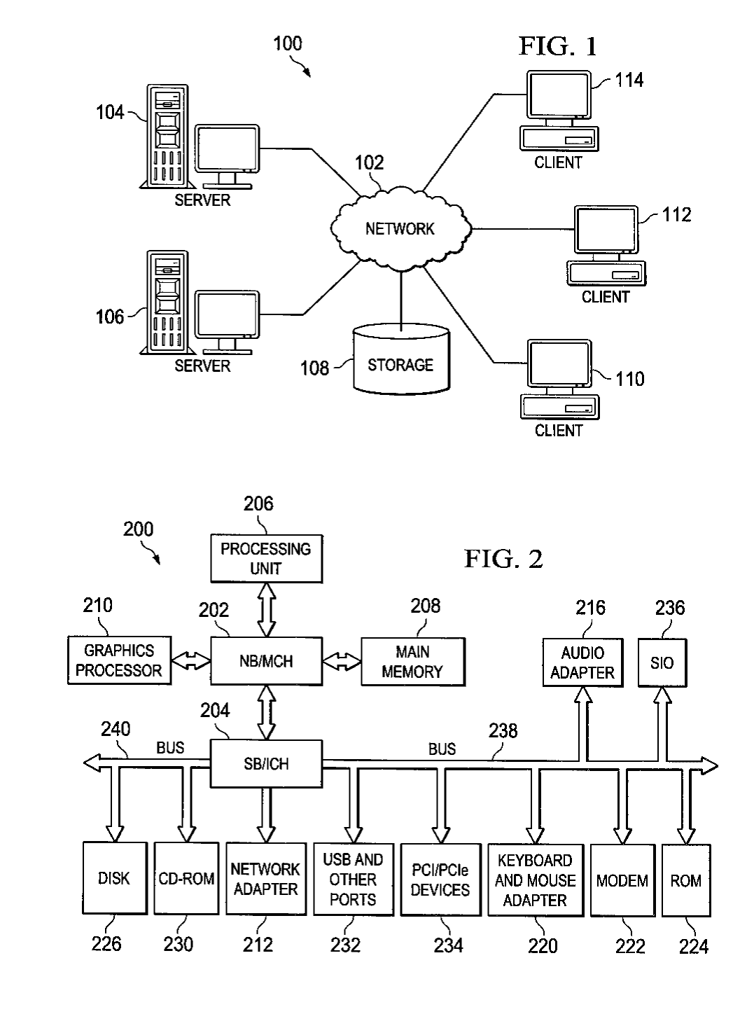

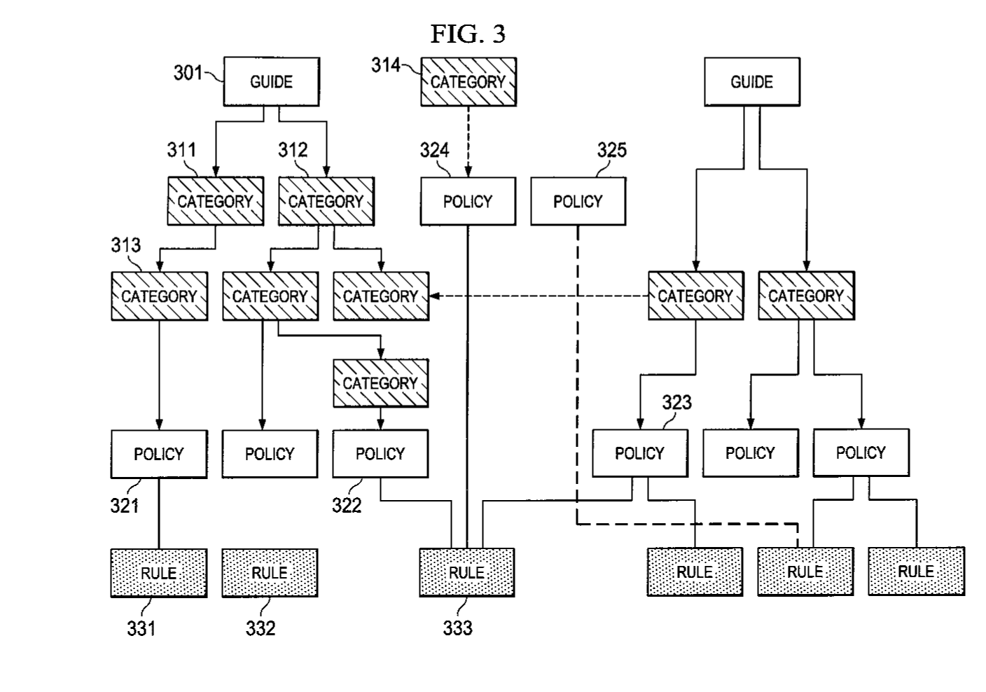

With reference now to the figures and in particular with reference to FIGS. 1-2, exemplary diagrams of data processing environments are provided in which illustrative embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an exemplary distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In one illustrative embodiment a system and methodology are provided for using hierarchical groupings to organize governance, risk, and compliance (CRC) policies and rules based on categorizations that can be arbitrarily represented by both predetermined and user-defined hierarchical policy naming schemes. Examples of regulations and regulatory guidelines that customers may be required to support and align with include, but are not limited to the following:

Sarbanes-Oxley Act (SOX);

The Basel II International Banking Accord (Basel II);

Internal Audit Services (IAS);

Security and Exchange Commission—Rule 17a-4 (SEC 17a-4);

Department of Defense Standard 5015.2 (DOD 5015.2);

Occupational Safety and Health Administration (OSHA);

Patriot Act;

Gramm-Leach-Biley Act (GLBA);

ISO 17799/ISO 27001/BS7799-2;

VISA Card Industry (PCI) Data Security Standards (DSS);

NASDAQ Rule 3010;

CoBIT Control Objectives;

National Institute of Standards and Technology 800-53 (NIST 800-53);

Statement on Auditing Standards No. 70 (SAS 70);

Federal Financial Institutions Examination Council (FFIEC);

Health Insurance Portability and Accountability Act (HIPAA);

Federal Deposit Insurance Corporation (FDIC) Regulations; and,

Internal Guidelines (e.g. IBM's Application Systems Control and Auditability (ASCA)).

Once GRC regulatory and compliance policies and rules are grouped to accommodate company policies, testing can be designed around groups of policies and/or rules and scheduled to align with requirements. By allowing the same policy or rule under multiple hierarchies, a single execution of a policy or rule can be associated with, and satisfy, multiple regulatory and compliance needs in one effort.

The system may include a graphical user interface (GUI) and a set of application program interfaces (APIs) for organizing policies and rules. The system may be embodied in a client, such as client 110. Alternatively, the system may be embodied on a server, such as server 104, for example, and the GUI may be accessed via a client, such as client 110. For instance, the GUI may be provided through a Web application or the like. The system may store a database of compliance rules. The database may be embodied in storage 108, for example. The database may store the different nodes in the hierarchy. Attributes are used to classify the node types. A set of attributes on the rules is used to maintain parent/child relationships.

The set of APIs is defined to provide a set of management operations

including the following: Add, Delete, Modify, Search, Attach/Detach Guide; Add, Delete, Modify, Search, Attach/Detach Policy; Add, Delete, Modify, Search, Attach/Detach Rule; Create, Delete, Insert, Attach/Detach, Search Nodes; View Hierarchy from Node; View Parent(s); View Children. The GUI is provided to manage the hierarchy and to provide visualization of the hierarchy with drill-down capabilities into sub-trees, and specific nodes and leaves in the hierarchy, including rules.

Thus, the illustrative embodiments provide a methodology to organize GRC constructs in user-defined hierarchical groupings. These user-defined groupings of the policies and rules that make up the core of the guidelines enable the flexible and robust organization, and management of the user's ARC confirmation activities.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an exemplary data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed. Computer code embodying the invention may be stored on a hard disk on a server system and downloaded to a requesting client system so that it can be stored on the client system hard disk or other storage media.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

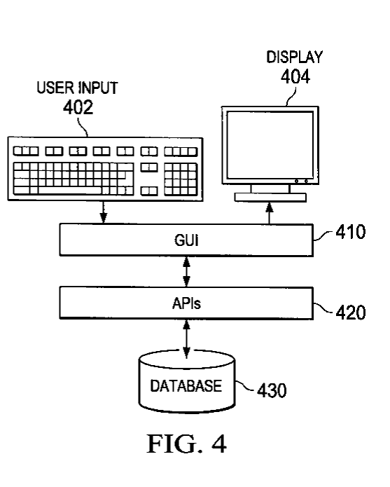

FIG. 3 is a diagram illustrating an example of a user-defined hierarchy of guidelines, categories, policies, and rules in accordance with an illustrative embodiment. In the illustrative embodiments, compliance (as well as governance and risk) policy definitions may be categorized into compliance rules and compliance policy organization nodes. Compliance rules are the core set of specifications that define in detail the rules that must be followed in a compliance policy. Rules specify what needs to be checked for compliance in a particular instance. Rules can be as granular and specifically formatted as required to satisfy their specific use.

A specific compliance policy may comprise multiple rules. For example, a compliance policy may specify that certain separation of duties (SOD) must be maintained, and several rules may be needed to check that specific activities are not in conflict with the SOD policies. A different rule may be needed for different pairs of duties that must be checked. Rules contain rule descriptions, which may take many forms. Examples of rules may include the following:

Text describing the details of the rule;

Rules specified in a rule language, which can be domain-specific; and,

Parameters to rules that can be modified to meet an entity's specific environment.

New rules can be created, existing rules can be modified, and rules can be deleted. There can be many rules to support a company's compliance policies. Key words, along with rule names and descriptions, are used to view and search the different rules.

Compliance rules can be used in many different ways. An organizational grouping structure can be defined on a set of rules to allow for multiple uses. The hierarchy may have some predefined structure, but can be as flexible as required to organize the rules in a fashion that corresponds to the use of the rules. The hierarchy may define several types of nodes including the following:

Guide node;

Category node; and

Policy node.

Additional node types can be arbitrarily created, named, and inserted into the hierarchy as desired.

The guide node represents a high level organization for a set of compliance policies. Guide nodes, such as node 301 in FIG. 3, may be used to represent different sets of compliance guidelines and/or regulations. For example, there may be a guide node for a company's SOX policies, and another guide node driven by the company's adoption of the CoBIT framework. A third guide node may apply specifically to the adherence to the PCI/DSS standard. Guide nodes contain zero to many category or policy nodes. New guides can be created. The description and set of sub nodes for a guide can be modified. Guide nodes can be deleted as needed. Operations to support the management of guide nodes include: adding new nodes, inserting new nodes anywhere in the organizational hierarchy that is needed, naming and renaming nodes, modifying, and deleting existing guide nodes.

Category nodes, such as nodes 311-314, in the hierarchy represent groupings of policies. Category nodes subdivide the policies of a guide node. For example, category nodes 311 and 312 subdivide guide node 301. However, a category node is not required to be organized underneath a guide, and can stand on its own. For example, category node 314 is not organized under a guide node. A specific category node can have one or more category nodes underneath, thus allowing for many levels of category nesting as desired. For example, category node 311 has category node 313 underneath.

The groupings allow the policies to be used in multiple ways. Categories can align the policies underneath a guide node to subdivide the guide-related policies into guide specific categorizations. For example, a CoBIT guide can contain categories and subcategories to represent the different sections and subsections of the CoBIT guideline document. Categories can also be used to organize policies and rules along company organization guidelines, or according to compliance management dictates or testing schedules.

The main use of the categories is to divide and subdivide compliance policies and then organize compliance rules in a manner that corresponds to how a company uses the policies. Operations to support the management of category nodes include: adding new nodes, inserting new nodes anywhere in the organizational hierarchy that is needed, naming and renaming nodes, modifying, and deleting existing category nodes.

Policy nodes, such as policy nodes 321-325, are used to attach rules into the compliance hierarchy. For example, policy node 321 is organized underneath category node 313. However, a policy node is not required to be organized underneath a category, and can stand on its own. For example, policy node 325 is not organized underneath a category node. Rules are created and then attached to policies. Policy nodes are the lowest level nodes in the compliance organizational hierarchy. Policy nodes can be sub nodes to zero or many category nodes, and policy nodes can have sub policy nodes underneath them. Operations to support the management of policy nodes include: adding new nodes, inserting new nodes anywhere in the organizational hierarchy that is needed, naming and renaming nodes, modifying, and deleting existing policy nodes.

There are also operations to manage attaching rules, such as rules 331-333, to the different policy nodes. A rule may be attached to multiple policy nodes. For example, rule 333 is attached to policy nodes 322, 323, and 324. Also note that in the depicted example, rule 332 is not underneath any policy nodes.

Guide, category and policy nodes and rules can all be assigned names by the user. This allows the user a maximum level of flexibility and intuitiveness. In general, there are operations necessary to manage the hierarchy. Category, sub category, policy, or sub policy nodes can be created, deleted, and inserted anywhere in the hierarchy. Operations also exist to view and describe the compliance policies and rules in different ways. For example, in a policy management system, the following views might be provided:

All the rules associated with a given node in the hierarchy, including all the rules for a given guide node;

All the policies for a given node in the tree;

All the categories a given rule or policy is associated with; or,

Which guide nodes a given rule or policy fall under.

The example GRC hierarchy shown in FIG. 3 is meant as an example, and is not meant to limit the illustrative embodiments. Lines with arrows are meant to illustrate relationships between nodes and sub nodes. Solid lines are meant to illustrate relationships between rules and the policy nodes with which they are associated. Dotted lines illustrate category or policy nodes that are not underneath a guide node.

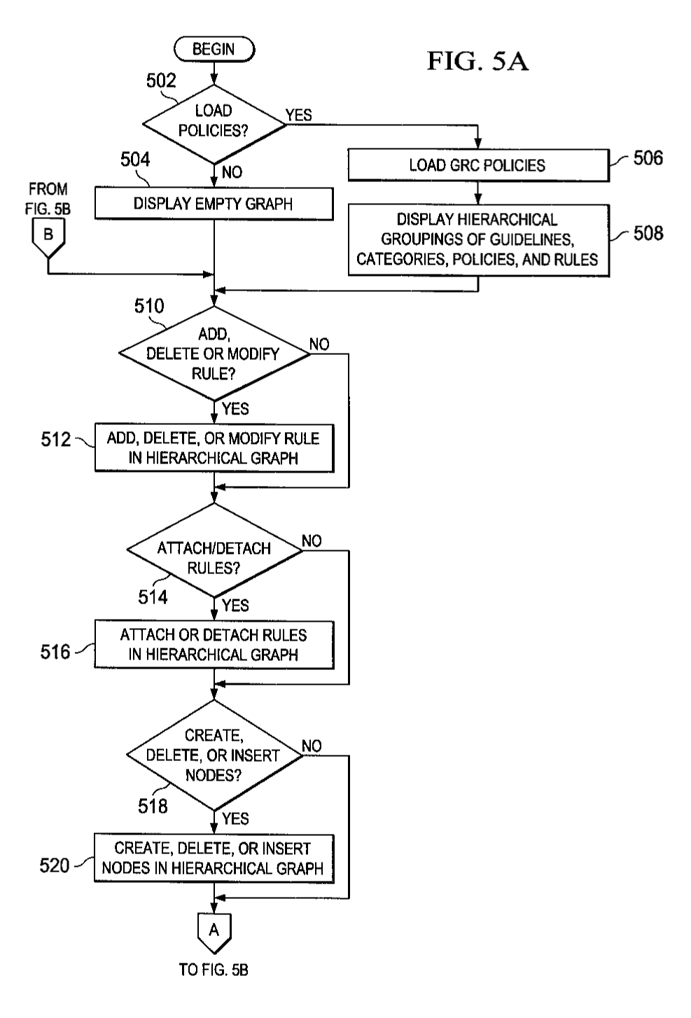

FIG. 4 is a block diagram of a system for managing groups of GRC regulatory and compliance policies and rules in accordance with an illustrative embodiment. The system comprises a graphical user interface 410 and a set of application programming interfaces 420. The GUI receives data from user input 402 and presents output to display 404.

The system may be embodied in a client, such as client 110 in FIG. 1, for example. Alternatively, the system may be embodied on a server, such as server 104 in FIG. 1, for example, and GUI 410 may be accessed via a client, such as client 110 in FIG. 1. For instance, the GUI 410 may be provided through a Web application or the like. The system may store compliance rules in GRC hierarchical database 430. Database 430 may be embodied in storage 108 in FIG. 1, for example. The database may store the different nodes in the hierarchy. Attributes are used to classify the node types. A set of attributes on the rules is used to maintain parent/child relationships.

The set of APIs 420 is defined to provide a set of management operations including the following: Add, Delete, Modify Rules; Attach/Detach Rules; Create, Delete, Insert Nodes; Search Rules; View Hierarchy from Node; and, View Parent(s). GUI 410 is provided to manage the hierarchy and to provide visualization of the hierarchy with drill-down capabilities into sub-trees, and specific nodes in the hierarchy including the rules.

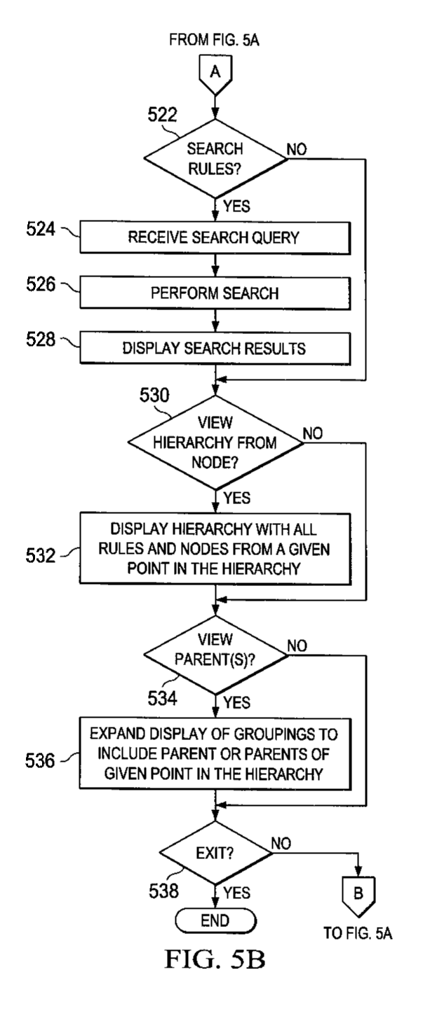

FIG. 5 is a flowchart illustrating operation of a system for managing groups of GRC regulatory and compliance policies and rules in accordance with an illustrative embodiment. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

Furthermore, the flowchart is provided to demonstrate the operations performed within the illustrative embodiments. The flowchart is not meant to state or imply limitations with regard to the specific operations or, more particularly, the order of the operations. The operations of the flowchart may be modified to suit a particular implementation without departing from the spirit and scope of the present invention.

With reference now to FIGS. 5A and 5B, operation begins, and the system queries the user whether to load existing polices and rules (block 502). If the system determines that the user does not wish to load existing policies and rules, the system displays an empty hierarchical graph for management (block 504). If the system determines that existing policies and rules are to be loaded in block 502, the system loads the CRC policies (block 506) and displays the hierarchical groupings of guidelines, categories, policies, and rules (block 508).

Next, the system determines whether the user wishes to add, delete, or modify a rule (block 510). If the user wishes to add, delete, or modify a rule, the system performs the add, delete, or modify operation and applies the operation to the hierarchical graph (block 512).

Thereafter, or if the user does not wish to add, delete, or modify a rule in block 510, the system determines whether the user wishes to attach or detach one or more rules (block 514). If the user wishes to attach/detach rules, the system performs the attach or detach operation and applies the operation to the hierarchical graph (block 516).

Thereafter, or if the user does not wish to attach/detach rules in block 514, the system determines whether the user wishes to create, delete, or insert nodes (block 518). If the user wishes to create, delete, or insert nodes, the system creates, deletes, or inserts guide, category, or policy nodes in the hierarchical graph (block 520).

Thereafter, or if the user does not wish to create, delete, or insert nodes in block 518, the system determines whether the user wishes to search rules (block 522). If the user wishes to search rules, the system receives a search query from the user (block 524), performs the search (block 526), and displays search results to the user (block 528). As an example, a user might wish to search for all rules that relate to access by users to critical applications, such as payroll, running on secure systems. As another example, a user might wish to search for all policies that are applicable to both CoBIT and PCI, which refer to a confidential database containing customer account numbers.

Thereafter, or if the user does not wish to search rules in block 522, the system determines whether the user wishes to view the hierarchy from a selected node (block 530). If the user wishes to view the hierarchy from a given node, the system displays the hierarchy with all rules and nodes from a given point in the hierarchy (block 532).

Thereafter, or if the user does not wish to view the hierarchy from a selected node in block 530, the system determines whether the user wishes to view the parent or parents of a selected node or rule (block 534). If the user wishes to view the parent(s) of a selected node or rule, the system expands the display of groupings to include the parent or parents of the given point in the hierarchy (block 536).

Thereafter, or if the user does not wish to view parent(s) in block 534, the system determines whether an exit condition exists (block 538). An exit condition may exist, for example, when the user closes the graphical user interface or saves the hierarchical groupings of nodes and rules, for example. If an exit condition does not exist, operation returns to block 510 to determine whether the user wishes to add, delete, or modify a rule. If an exit condition exists in block 538, operation ends.

Thus, the illustrative embodiments provide a method to organize GRC policies in user-defined hierarchical groupings to organize the policies and rules that make up the core of the guidelines so that they can be organized, managed, tested, and used in a flexible manner. The illustrative embodiments provide a methodology for efficiently organizing and managing the nodes in the hierarchy, along with a set of operations that allow the user to manage the hierarchy to make it most useful.

It should be appreciated that the illustrative embodiments may take the form of a specialized hardware embodiment, a software embodiment that is executed on a computer system having general processing hardware, or an embodiment containing both specialized hardware and software elements that are executed on a computer system having general processing hardware. In one exemplary embodiment, the mechanisms of the illustrative embodiments are implemented in a software product, which may include but is not limited to firmware, resident software, microcode, etc.

Furthermore, the illustrative embodiments may take the form of a computer program product accessible from a computer-usable or computer-recordable medium providing program code recorded thereon for use by or in connection with a computer or any instruction execution system. For the purposes of this description, a computer-usable or computer-recordable medium can be any apparatus that can contain, store, communicate, propagate, or transport the program for use by or in connection with the instruction execution system, apparatus, or device.

The medium may be an electronic, magnetic, optical, electromagnetic, or semiconductor system, apparatus, or device. Examples of a computer-recordable medium include a semiconductor or solid state memory, magnetic tape, a removable computer diskette, a random access memory (RAM), a read-only memory (ROM), a rigid magnetic disk, and an optical disk. Current examples of optical disks include compact disk-read-only memory (CD-ROM), compact disk read/write (CD-R/W) and DVD.

The program code of the computer program product may comprise instructions that are stored in a computer readable storage medium in a client or server data processing system. In a client data processing system embodiment, the instructions may have been downloaded over a network from one or more remote data processing systems, such as a server data processing system, a client data processing system, or a plurality of client data processing systems using a peer-to-peer communication methodology. In a server data processing system embodiment, the instructions may be configured for download, or actually downloaded, over a network to a remote data processing system, e.g., a client data processing system, for use in a computer readable storage medium with the remote data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for managing governance, risk, or compliance policies, the method comprising:
providing a graphical user interface to provide management of a hierarchical grouping of guide nodes, category nodes, and policy nodes, wherein each rule of the governance, risk or compliance policy is organized under one or more policy nodes;
receiving input from a user via the graphical user interface to manage the hierarchical grouping of guide nodes, category nodes, and policy nodes; and
storing the hierarchical grouping of guide nodes, category nodes, policies, and rules to a database.

2. The method of claim 1, wherein at least one category node is organized under a guide node.

3. The method of claim 1, wherein at least one category node is a sub category node that is organized under a category node.

4. The method of claim 1, wherein at least one category node is not organized under a guide node.

5. The method of claim 1, wherein at least one policy node is organized under a category node.

6. The method of claim 1, wherein at least one policy node is not organized under a category node or a guide node.

7. The method of claim 1, wherein a set of attributes is used to classify a node type of a given node in the hierarchical grouping of guide nodes, category nodes, and policy nodes.

8. The method of claim 1, wherein a set of attributes on one or more rules maintains a parent/child relationship.

9. The method of claim 1, further comprising:
providing an application program interface that provides a set of operations to manage, name, rename, modify, add, delete, search, link, relink, and manipulate each of the guide nodes, category nodes, policy nodes, and rules.

10. The method of claim 1, wherein steps of providing a graphical user interface, receiving input from a user, and storing the hierarchical grouping of guide nodes, category nodes, policies, and rules to a database are performed by a computer readable program recorded on a computer usable medium at a server system, wherein the computer readable program is configured to be downloaded to a requesting system.

11. A data processing system for managing governance, risk, or compliance policies, the data processing system comprising:
a processor; and
a memory coupled to the processor, wherein the memory contains instructions which, when executed by the processor, cause the processor to:
provide a graphical user interface to provide management of a hierarchical grouping of guide nodes, category nodes, and policy nodes, wherein each rule of the governance, risk or compliance policy is organized under one or more policy nodes;
receive input from a user via the graphical user interface to manage the hierarchical grouping of guide nodes, category nodes, and policy nodes; and
store the hierarchical grouping of guide nodes, category nodes, policies, and rules to a database.

12. The data processing system of claim 11, wherein at least one category node is organized under a guide node.

13. The data processing system of claim 11, wherein at least one policy node is organized under a category node.

14. The data processing system of claim 11, wherein a set of attributes is used to classify a node type of a given node in the hierarchical grouping of guide nodes, category nodes, and policy nodes.

15. The data processing system of claim 11, wherein a set of attributes on one or more rules maintains a parent/child relationship.

16. The data processing system of claim 11, wherein the instructions comprise an application program interface that provides a set of operations to manage, name, rename, modify, add, delete, search, link, relink, or manipulate each of the guide nodes, category nodes, policy nodes, and rules.

17. A computer program product comprising a computer useable medium having a computer readable program, wherein the computer readable program, when executed on a computing device, causes the computing device to:
provide a graphical user interface to provide management of a hierarchical grouping of guide nodes, category nodes, and policy nodes, wherein each rule of the governance, risk or compliance policy is organized under one or more policy nodes;
receive input from a user via the graphical user interface to manage the hierarchical grouping of guide nodes, category nodes, and policy nodes; and
store the hierarchical grouping of guide nodes, category nodes, policies, and rules to a database.

18. The computer program product of claim 17, wherein the computer readable program comprises an application program interface that provides a set of operations to manage, name, rename, modify, add, delete, search, link, relink, and manipulate each of the of guide nodes, category nodes, policy nodes, and rules.

19. The computer program product of claim 17, wherein the computer readable program comprises instructions that are stored in a computer readable storage medium in a data processing system, and wherein the instructions were downloaded over a network from a remote data processing system.

20. The computer program product of claim 17, wherein the computer readable program comprises instructions that are stored in a computer readable storage medium in a server data processing system, and wherein the instructions are downloaded over a network to a remote data processing system for use in a computer readable storage medium with the remote data processing system.
